(19) United States
(12) Patent Application Publication
(10) Pub. No.: US 2003/0097885 A1
(43) Pub. Date: May 29, 2003

(54) Lateral displacement tensiometer and method for measuring tension

(76) Inventor: Terrance A. Kell, Las Vegas, NV (US)

Correspondence Address: WEISS & MOY PC, 4204 NORTH BROWN AVENUE, SCOTTSDALE, AZ, 85251, US

(21) Appl. No.: 09/961,783

(22) Filed: Sep. 24, 2001

(51) Int. Cl. G01L 1/00

(52) U.S. Cl. 73/862

(57) ABSTRACT

A tensiometer and method for measuring tension measure strain produced by a lateral displacement of a flexible line under tension. A block having a cylindrical cavity following a curved path is used to displace the flexible line. Tension in the line produces compressive stress within the block in the direction of the radius of curvature and tensile stress in the direction opposite the radius of curvature. A resistive strain gauge is used to measure strain due to either the compressive stress or tensile stress and a measurement circuit generates either a graphical display in accordance with standard tension measurement units, an audible or visual alarm when tension exceeds a predetermined threshold, or both.

### BACKGROUND OF THE INVENTION

1. Field of the Invention

The present invention relates generally to mechanical stress measuring devices, and more specifically, to a tensionometer for measuring tension on flexible lines.

2. Background of the Invention

It is often necessary to measure tension on ropes, cables, wires and other structural or non-structural flexible lines. Typicaly tensiometers (or tension gauges) for measuring tension are inserted within the force path of the line, by attaching a cable to each end of the tensiometer.

Tensiometers cannot sometimes be easily inserted in the force path of the flexible line, and doing so might compromise the integrity of the line due to potential failure of the tension gauge. Additionally, in some circumstances it may not be possible to remove tension from a line in order to measure the stress on the line, since the line may be structurally necessary or necessary for safety.

For example, firefighters and other rescue personnel are required to place a specified tension on lines that are used for rescue operations, prior to commencing rescue. Inserting a tensiometer into the force path of a line used for rescue might compromise the safety of the set-up, and makes for a complicated operation during an emergency.

Flexible lines also must be tested and tensiometers calibrated periodically. Removing a tensiometer from the force path of the line is inconvenient, and calibration of the tensiometer subject to repeating the proper reference tension on a line.

Therefore, it would be desirable to provide a tensiometer that may be used to measure line tension quickly and that does not require insertion within the force path of a line. It would further be desirable to provide a tensiometer that is easily and repeatably calibrated.

### SUMMARY OF THE INVENTION

The above objective of providing a tensiometer that does not require insertion within the force path of a measured line is achieved in a tensiometer and method for measuring tension on a flexible line. The tensiometer includes a displacing surface for forcing the flexible line to curve around the displacing surface, a measuring surface mechanically coupled to the displacing surface, and a strain gauge mechanically coupled to the measuring surface for measuring a strain within said measuring surface caused by a stress within the displacing surface.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1A is a pictorial diagram depicting a top view of a tensiometer in accordance with an embodiment of the present invention.

FIG. 1B pictorial diagram depicting a side view of a tensiometer in accordance with an embodiment of the present invention.

FIG. 1C pictorial diagram depicting a cross-section view of a tensiometer in accordance with an embodiment of the present invention.

FIG. 2 is a schematic diagram depicting circuits in accordance with an embodiment of the present invention.

FIG. 3A and FIG. 3B are pictorial diagrams depicting alternative embodiments of the present invention

FIG. 4 is a pictorial diagram of an embodiment of the invention including an overload protection mechanism.

### DETAILED DESCRIPTION OF THE PREFERRED EMBODIMENTS

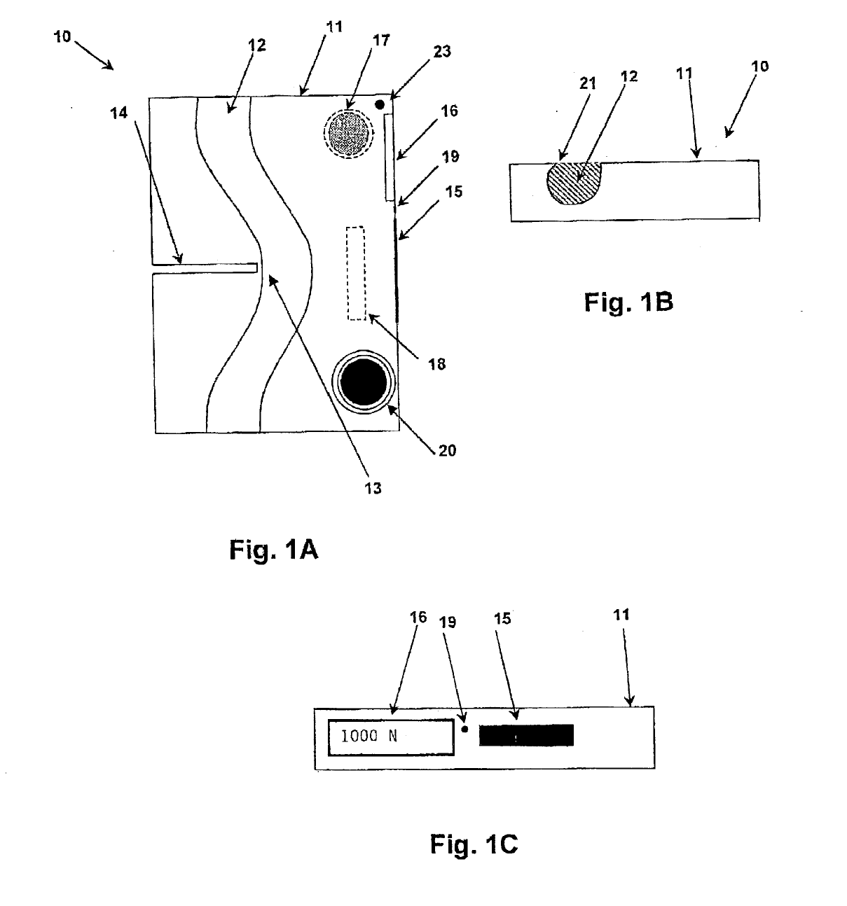

Referring now to the figures and in particular to FIG. 1A, a top view of a tensiometer 10 in accordance with an embodiment of the present invention is shown. A rectangular block 11, generally of metal, but which may be a material selected suitable for a particular range of tension measurement, has a cylindrical channel 12 cut through from one end of block 11 to the other end. The entry and exit (which are interchangeable) of the cylindrical channel lie on the same axis through the block, so that a flexible line introduced to the cylindrical channel will lie on a straight line outside of block 11. While the illustrative embodiment depicts a cylindrical channel, it should be understood that channels of other cross-section shapes may be used, as well such as rectangular or triangular channel cross-sections.

A flexible line is inserted within the cylindrical channel, and the displacement wall 13 of the curve (convex wall in the depicted plane) causes the line to be displaced from the axis on which the entry and exit lie. Within block 11, the lateral displacement around displacement wall 13 causes compressive stress within the region surrounding convex wall 13 and tensile stress is produced in the opposite wall (measurement wall or concave wall in the depicted plane). A resistive strain gauge 15 is mounted to the side of block 11 and measures tensile strain resulting from the tensile stress on the measurement wall.

While the embodiments depicted herein show a strain gauge mounted on a surface having a tensile strain, configurations mounting the strain gauge on a surface under compressive stress and having a resulting compressive strain are also contemplated by the invention and should be understood as equivalent structures.

A notch 14 may be cut in the side opposing resistive strain gauge 15, permitting the compressive stress produced at displacement wall 13 to elastically deform block 11 more readily due to the reduced cross-section at notch 14, improving the effective sensitivity of resistive strain gauge 15. A notch may alternatively be cut in the opposing side. The function of the notch is to increase the resulting deformation due to the strain. Considerations for the location of the notch include whether the strain gauge is mounted to measure compressive strain or tensile strain and where the maxima of the strains are located within the block. Positions other than the maxima may also be used to decrease the relative effect of the notch. The strain gauge may be mounted to the bottom or top surface of the block, as well as the side, as tensile or compressive forces are present throughout the block, depending on the configuration of the tensiometer structure.

Measurement circuits 18 may be embedded within block 11 to couple resistive strain gauge 15 to a display 16, an alarm buzzer 20, an alarm indicator 23 or any combination of the above. A battery 17 is used to power measurement circuits 18, display 16 and alarm buzzer 20. Alternatively, or in combination, a solar cell may be used to provide power for measurement circuits 18 when ambient light is sufficient.

Display 16, which is generally an LCD display, can be customized to a particular set of tension units or measurement indication. Alternatively, displays may be LED or LCD bar graphs, analog gauges, or a binary indication such as a single LED for indicating that a predetermined tension level has been exceeded or has not been exceeded. The display may be a numeric display in units of force to indicate tension, or may be settable or pre-programmed for a material with a particular ultimate tensile strength or cross-sectional area to yield percentage of ultimate stress, or a stress value indication in force/area units. The alarm buzzer may also be set or preprogrammed to produce an audible alarm when any of the above values reach a predetermined threshold. Such an audible alarm is useful for installations where tensiometer 10 may be left in place or with several tensiometers installed on several flexible lines, to produce an indication audible at a distance. Similarly, alarm indicator 23 which is depicted in the illustrations as an LED, but may alternatively be any other form of lamp, provides a visual indication that is readable at a distance.

Referring now to FIG. 1B, a side view of tensiometer 10 is depicted. Display 16 is mounted on and is visible from the side of block 11 (although other mounting locations are possible such as on the top face). Resistive strain gauge 15 is mounted or deposited on the side surface of block, but may be recessed beneath the surface and covered for protection. Button switch 19 is included for mode selection (e.g., units, force vs. tensile strength percentage, etc.) and other buttons and functions may be included for programming alarm thresholds, line material, clearing stored values in memory, etc. Button switch 19 may serve a dual function such as a power-on switch for use in waking measurement circuits after an automatic turn-off timeout has occurred and then for subsequent use as a mode selection switch.

Referring now to FIG. 1C, an end view of tensiometer 10 is depicted. Cylindrical channel 12 enters (or exits) through the end wall as shown. Displacement wall 13 is concave in the plane displayed (and above-described as convex in the plane of FIG. 1A) in order to assist retention of a flexible line, but this is not a requirement of the present invention. As tension is applied, the flexible line will be secured to displacement wall 13 by the lip 21 of displacement wall 13. Alternatively, or in combination, a separate safety latch mechanism may be incorporated in tensiometer to provide retention of a flexible line.

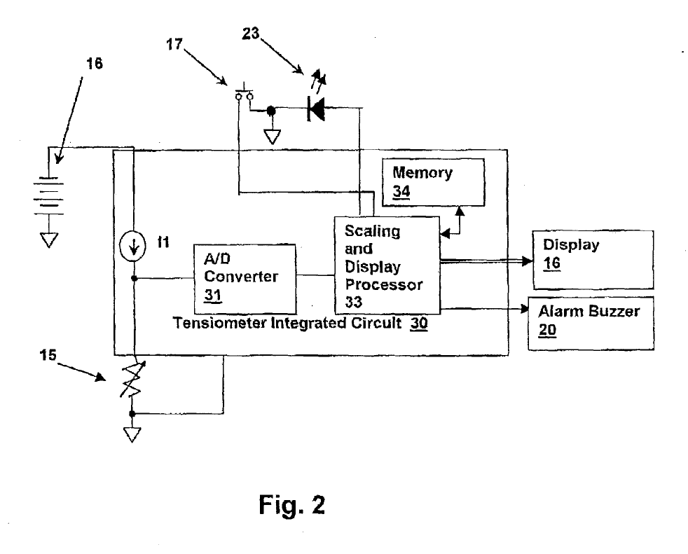

Referring now to FIG. 2, circuits within tensiometer 10 are depicted. A tensiometer integrated circuit 30 provides the essential functionality of the tensiometer 10 measuring system, but discrete implementations are possible and are contempleted by the present invention. Current source 11 provides a reference current through resistive strain gauge 15. The voltage across resistive strain gauge 15 is proportional to the strain detected by strain gauge 15 and is sampled by an analog-to-digital (A/D) converter 31, which may be an A/D converted embedded within an embedded microcontroller. Scaling and display processor 33, converts the digital output of A/D converter 31 to the signals required to display the desired tension unit outputs to display 16 and values for potential storage in a memory 34. Button switch 17 is coupled to scaling and display processor 33 to provide user input for mode selection and programming, but any number of buttons might be used to facilitate programming.

Alarm buzzer 20, is generally a piezoelectric element driven by a frequency generating circuit (which may be a control pin provided buy scaling and display processor 33). Alarm buzzer 20 is coupled to scaling and display processor 33, so that an alarm may be generated if measured strain exceeds a programmed predetermined level. The level may be user selected via button switch 17, or may be factory pre-programmed to a predetermined level. The visual alarm lamp 23, alarm buzzer 20 and/or display 16 may be used to provide a low battery indication.

Memory 34 is coupled to scaling and display processor 33 and contains non-volatile program instruction storage and volatile data storage. Electrically-alterable memory may be used to provide scaling of particular units, customization for particular flexible line materials, calibration of a particular strain gauge 15 and block 11 combination, and compensation for block material. Memory 34 may be used to store strain values, yielding a history of tension within a flexible line. Use of memory 34 to yield a data-recording tensiometer permits display of such information as number of load cycles encountered in a particular installation, peak tensile load, number of times the peak tensile load is reached, etc. Additionally, an external interface to integrated circuits 30 via an external connection, providing a means for transferring data from tensiometer 10 to a computer or other instrument. The data sample rate may be made adjustable for conservation of battery power and the resolution and sample rate may be made adjustable to conserve storage space within memory 34.

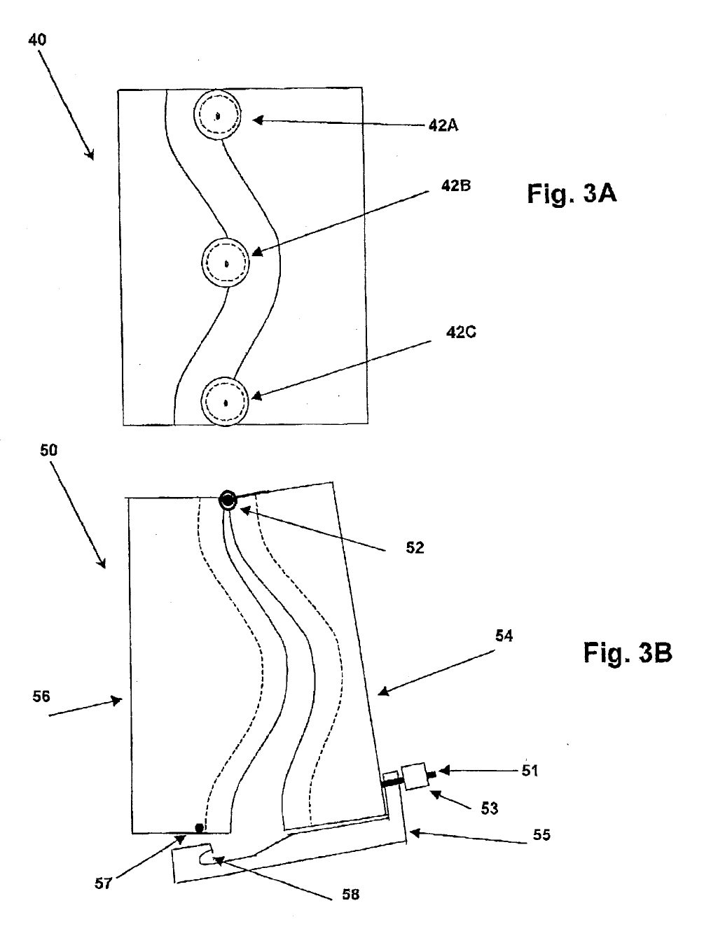

Referring now to FIG. 3A, a tensiometer frame 40 in accordance with an alternative embodiment of the invention is depicted. The mechanical details of the frame are shown without a display or any of the electronic components to provide clarity of illustration. In the alternative embodiment of FIG. 3A, one or more pulleys 42A-42C are used to permit a flexible line to slip more freely through frame 40. Three pulleys may be used as depicted, or a single pulley 42B may be used at the point of maximum displacement. Alternatively, two pulleys may be used at the exit and entry locations (pulleys 42A and 42C). In order to insert a flexible line that is already under tension, one or more of pulleys 42A-42C may be made removable with a slip pin arrangment (generally pulley 42B) and a lever may be provided to temporarily displace the flexible line, or an external tool may be provided so that the pulley(s) may be inserted easily along with the flexible line.

Referring now to FIG. 3B, a tensiometer 50 having a clamshell frame is depicted. The frame comprises a first portion 56 including the displacement surface, and a second portion 54 for retaining a flexible line against the displacement surface by completing a cylindrical channel. First portion 56 is attached to second portion 54 by a hinge 52. A latching mechanism 55 permits securing first portion 56 and second portion 54 together by hooking a recess 58 in latching mechanism 55 over a pin 57 on housing first portion 56. Latching mechanism is secured to second portion 54 via a nut 53 threaded onto a bolt 51 that attaches latching mechanism 55 to second portion 54. Alternatively, two latches or other bolting arrangements will be apparent to those of skill in the art so that a clamshell frame for the tensiometer may be implemented and are contemplated by the present invention.

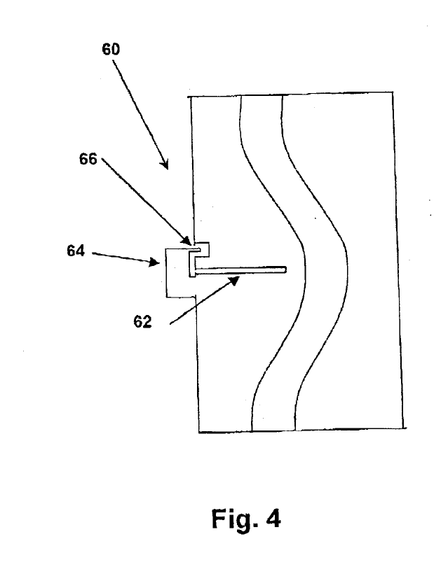

Referring now to FIG. 4, a tensiometer frame 60 including an overload protection mechanism is depicted. A notch 62 is used to provide a greater deformation in response to compressive stress as described for the embodiments depicted above, but an additional cam 64 is machined as an integral part of frame 60. At the end of cam 64 is a stop 66 that will contact a wall 68 of a second notch machined in frame 60 if an excessive compressive force is applied across notch. The features of the overload protection mechanism may also me molded or otherwise formed in frame 60 according to the particular materials and processes used to fabricate frame 60. Alternatively, an externally attached stop might be used, providing a mechanical limit of travel for the walls of notch 62.

Within the block tensiometer frame included in various embodiments of the present invention, block material may be varied by application, for example, a polymer block may be used for measuring low tensile strength flexible lines, while a steel block might be used for measuring high tensile strength cables since the more elastic the material chosen, the higher stain level produced at strain gauge 15. The material should be chosen so that plastic deformation does not occur at the maximum tension levels intended for measurement with a particular tensiometer. The shape of the curvature of displacement wall (generating the amount of displacement) may also be tailored to particular tension levels. For example, in a high-tension application, a low displacement (slight curvature) will yield lower strain within strain gauge 15.

While the invention has been, particularly shown and described with reference to the preferred embodiments thereof, it will be understood by those skilled in the art that the foregoing and other changes in form, and details may be made therein without departing from the spirit and scope of the invention.

What is claimed is:

1. A tensiometer for measuring tension on a flexible line, comprising:
a frame having an included curved channel for accepting said flexible line, said channel defined by a inwardly convex displacing wall for forcing a path of said flexible line to curve around said displacing wall; and
a strain gauge mechanically coupled to said displacing wall for measuring a strain caused by a compressive stress within said displacing wall.

2. The tensiometer or claim 1, wherein said frame further comprises a measuring wall on an opposite side of said channel from said displacement wall and mechanically coupled to said displacing wall, and wherein said strain gauge is mounted on said measuring wall and measures a tensile strain generated at said measuring wall in response to said compressive stress within said displacing wall.

3. The tensiometer of claim 1, wherein said strain gauge is mounted on a portion of said frame corresponding to said displacing wall and thereby measures a compressive strain generated in response to said compressive stress.

4. The tensiometer of claim 1, wherein said frame comprises a substantially rectangular solid block, wherein said displacing wall defines a cylindrical curved channel through said block, with an entry and exit through the ends of said block, said entry and exit coaxial with an axis through said block normal to said entry and said exit, and wherein said cylindrical channel follows a path within said block that is displaced from said axis in a direction opposite said displacing wall.

5. The tensiometer of claim 4, wherein said displacing wall intersects a top surface of said block, whereby said cylindrical channel has a cross-sectional opening to the top of said block, whereby said flexible line may be inserted from said top surface prior to application of tension to said flexible line.

6. The tensiometer of claim 5, wherein said block is notched from said top surface to a bottom surface of said block from a side of said block in a direction normal to said displacing wall, whereby said strain may be increased due to bending across said notch.

7. The tensiometer of claim 6, wherein said block further includes an overload protection mechanism providing a mechanical limit to bending of across said notch.

8. The tensiometer of claim 5, wherein a cross section of said channel is substantially perpendicular to said top surface in a region near an intersection of a wall opposite said displacing wall with said top surface, whereby said flexible line may be readily introduced from said top surface, and wherein said cross section is concave in a region near said intersection of said displacing wall with said top surface, whereby said flexible line may be retained by said concavity.

9. The tensiometer of claim 4, wherein said frame further comprises a friction reducing coating applied to at least a portion of said cylindrical curved channel, whereby movement of said flexible line through said cylindrical curved channel is improved.

10. The tensiometer of claim 4, wherein said frame further comprises one or more pulleys mounted adjacent to said curved cylindrical channel, whereby movement of said flexible line through said cylindrical curved channel is improved.

11. The tensiometer of claim 4, wherein said frame comprises a first portion including said displacing wall and a second portion including a wall of said cylindrical curved channel opposite said displacing wall, and a latching mechanism for attaching said first portion to said second portion whereby said flexible line may be inserted by opening said latching mechanism and whereby said tension may be measured when said latching mechanism is closed.

12. The tensiometer of claim 11, wherein a first end of said second portion is attached to a first end said first portion by a hinge and wherein said latching mechanism is disposed at a second end of said second portion and latches said second portion to a second end of said first portion.

13. The tensiometer of claim 1, further comprising;
a measurement circuit electrically coupled to said resistive strain gauge mounted within said frame; and
a display mounted on a surface of said frame and coupled to said resistive strain gauge for displaying an indication of said tension on said flexible line.

14. The tensiometer of claim 13, further comprising an alarm buzzer mounted conformal to an exterior surface of said frame and electrically coupled to said measurement circuit for producing an alarm when said tension on said flexible line has reached a predetermined level.

15. The tensiometer of claim 13, further comprising a battery mounted within said frame for powering said measurement circuit.

16. The tensiometer of claim 13, wherein said measurement circuit includes a display scaling processor coupled to an input to said display for producing a display in accordance with standard measures of tension.

17. The tensiometer of claim 16, further comprising a switch mounted within said frame and accessible at a surface of said frame for changing a mode of said display.

18. The tensiometer of claim 16, further comprising a memory storage coupled to said display scaling processor, and wherein said display scaling processor stores values within said memory for recording a history of said tension on said flexible line.

19. A tensiometer for measuring tension on a flexible line, comprising;
means for producing a compressive stress by displacing said flexible line;
means for producing and measuring a strain corresponding to said compressive stress; and
means for indicating said tension on said flexible line in conformity with said measured strain.

20. A tensiometer for measuring tension on a flexible line, comprising:
a substantially rectangular solid block including cylindrical channel therethrough following a path that is displaced from an axis coaxial with an entrance and an exit of said channel to and from said block, whereby said displacement forces a path of said flexible line to be displaced away from said axis in a region within said block producing a compressive stress within said block along said axis maximized around a maxima of said displacement; and
a strain gauge mechanically coupled to said block along said axis near said maxima of said displacement for measuring strain generated by said compressive stress.

21. A method of measuring tension on a flexible line, comprising the steps of:
displacing said flexible line with a displacement wall; and
measuring tension on said flexible line by measuring a strain corresponding to compressive stress at said displacement wall.

22. The method of claim 21, comprising inserting said flexible line through a substantially cylindrical channel passing through a substantially rectangular block, and wherein said displacing occurs in response to said inserting said flexible past a displacement in said cylindrical channel.

23. The method of claim 22, wherein said inserting is performed from a top surface of said block, whereby said flexible line may be placed throughout said substantially cylindrical channel at one time.

24. The method of claim 22, wherein said inserting is performed by opening clamshell portions of said block, whereby said flexible line may be inserted within said channel, and further comprising closing said clamshell portions of said block, whereby said measuring may be performed in response to said closing.

25. The method of claim 21, further comprising:
detecting when said measured tension has exceeded a predetermined threshold; and
sounding an audible alarm in response to said detecting.

26. The method of claim 21, further comprising generating a visible display in response to said measuring, wherein said tension on said line is displayed in a format consistent with standard tensile measurement units.
